(19) United States
(12) Patent Application Publication
(10) Pub. No.: US 2004/0066902 A1
(43) Pub. Date: Apr. 8, 2004

(54) X-ray generator

(76) Inventors: George William Fraser, Leicestershire (GB); Adam North Brunton, Oxfordshire (GB)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/416,828

(22) PCT Filed: Nov. 13, 2001
(86) PCT No.: PCT/GB01/04998

(30) Foreign Application Priority Data
Nov. 14, 2000 (GB) 0027759.0

(51) Int. Cl. G21K 1/00

(52) U.S. Cl. 378/145

(57) ABSTRACT

There is disclosed an optic coupled X-ray generator comprising:a point or near point source of X-rays; and a microchannel plate optic comprising a plurality of channels positioned with respect to the source of X-rays so as to intercept a portion of the X-rays emitted by the source, and to focus the intercepted X-rays to a spot with a gain of greater than one.

This invention relates to an optic coupled X-ray generator, in particular to a microchannel plate optic coupled X-ray generator capable of providing high gains in X-ray intensity, and high spectral brightness.

In many diverse applications such as materials analysis, protein and other X-ray crystallography and dermatology, it is of interest to generate X-rays with high spectral brightness (photons per unit solid angle per unit emitting area per 0.1% bandwidth per second). The brightest X-ray sources are synchrotrons, which are large and expensive national facilities to which access is limited. For normal laboratory use, high brightness is usually achieved by rotating anode generators requiring high power (˜5KW).

The basic problem with laboratory X-ray sources is that the X-ray emission produced by the electron beam striking the solid anode is isotropic i.e. the “per unit solid angle term” in the brightness formulation determines the brightness attainable.

In some applications, for example, in protein crystallography, where samples are of small size, it is necessary or desirable to illuminate only a small area.

To achieve a small area illumination with a conventional source requires the use of a pinhole collimator, which is incompatible with high spectral brightness.

An optic-coupled X-ray source, known as “the Microsource” has been pioneered by Bede Scientific in the UK, using replicated nickel ellipsoidal “micromirrors” manufactured in the Czech republic by REFLEX sro. However, the replicated Ni optics are quite expensive to manufacture. The Bede Microsource gives a spot size of 1 mm diameter at 55 cm from the X-ray anode. A smaller spot size would be desirable. Furthermore, replicated micromirrors are likely to be tuned to a specific energy, rather than being capable of focusing a broad range of X-ray energies. Focusing of X-rays with microchannel plates is disclosed in S W Wilkins, A W Stevenson, K A Nugent, H Chapman and S Steenstrup, Rev.Sci.Instrum. 60 (1989) 1026.

The present invention overcomes the above mentioned problems and disadvantages, and provides an optic coupled X-ray generator which can provide high intensity gains, small spot sizes and consequently high spectral brightness. Furthermore, the X-ray generator is relatively economical to produce, and the optic is capable of being used with a wide range of X-ray energies.

According to the invention there is provided an optic coupled X-ray generator comprising:

a point or near point source of X-rays; and

a microchannel plate optic comprising a plurality of channels positioned with respect to the source of X-rays so as to intercept a portion of the X-rays emitted by the source, and to focus the intercepted X-rays to a spot with a gain of greater than one.

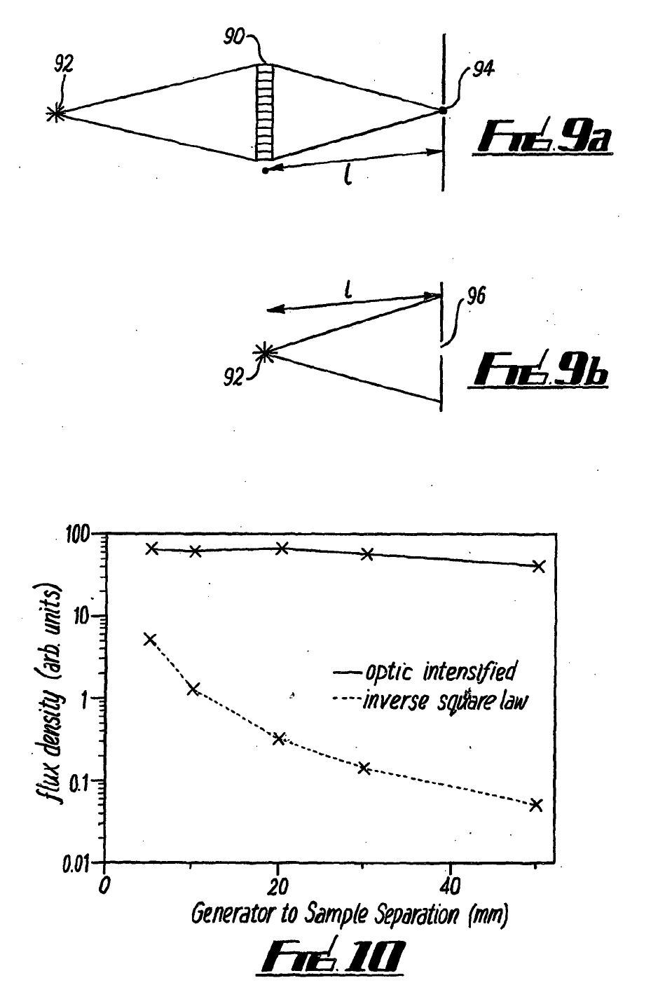

Gain is defined as the ratio of X-ray intensity in the spot focused by the microchannel plate optic to the X-ray intensity through a pinhole of the same diameter as the focused spot, the pinhole being at the same distance from the source as the focused spot is from the optic. FIG. 9a) depicts the first instance, in which an optic 90 focuses X-rays from a source 92 to a spot 94, the distance between optic 90 and spot 94 being 1 FIG. 9b) depicts the latter instance, in which a pinhole aperture 96 is positioned at distance 1 from X-ray source 92.

The microchannel plate optic maybe flat, ie., the microchannel plate may have a front face which is substantially coplanar with a back face of the plate. This is in contrast to a curved, or “slumped” plate. However, curved plates may be used in conjunction with the invention instead. In either instance (but preferably in the instance in which the plate is flat) the thickness of the microchannel plate optic may vary as a function of the radial distance from the centre of the optic. The thickness of the plate may vary substantially according to the function 1.414. D.Ls/r where D is the width of the channels, L_{S} is the distance from the point source to the centre of the optic, and r is the radial distance from the centre of the optic.

The microchannel plate optic may comprise a plurality of channels of square cross section, in which opposing sides of channels are parallel, and in which the longitudinal axes of the channels are parallel.

The distance between the source and the microchannel plate optic may be in the range 0.5 to 20 cm, preferably in the range 2 to 12 cm. Surprisingly, high gains can be achieved when the distance between the source and the microchannel plate optic is relatively large, such as greater than 3 cm. It has been found that the high gains offset the reduced flux reaching the optic at larger source-optic separations. This provides the considerable advantage of allowing the sample to be positioned at a relatively large distance from the optic.

The microchannel plate optic may focus the intercepted X-rays to a spot of less than 0.5 mm full width at half maximum (FWHM), preferably less than 0.25 mm FWHM, most preferably less than 0.15 mm FWHM. Small spot sizes can provide high gains. Particularly high gains can be achieved when small spot sizes and relatively large source-microchannel plate optic separations are employed.

The surfaces of the channels may comprise a metal. The metal may be nickel.

The source of X-rays may comprise an anode. The anode may comprise aluminium or magnesium.

The generator may be adapted to focus the intercepted X-rays to a spot with a gain of greater than 30, preferably greater than 50, most preferably greater than 100.

The optic coupled X-ray generator may be used in materials analysis, X-ray crystallography, dermatology or surface science.

X ray generators in accordance with the invention will now be described with reference to the accompanying drawings, in which:-

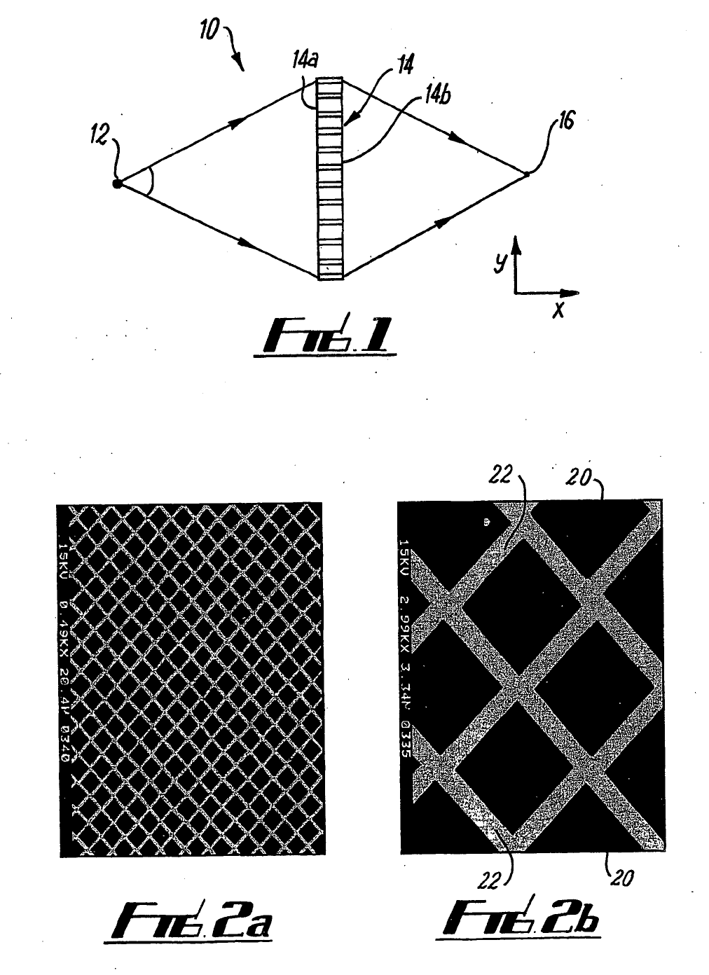

FIG. 1 is a schematic diagram of an X-ray generator

FIG. 2 shows a) a SEM image of a microchannel plate and b) an enlarged view of the channels shown in a);

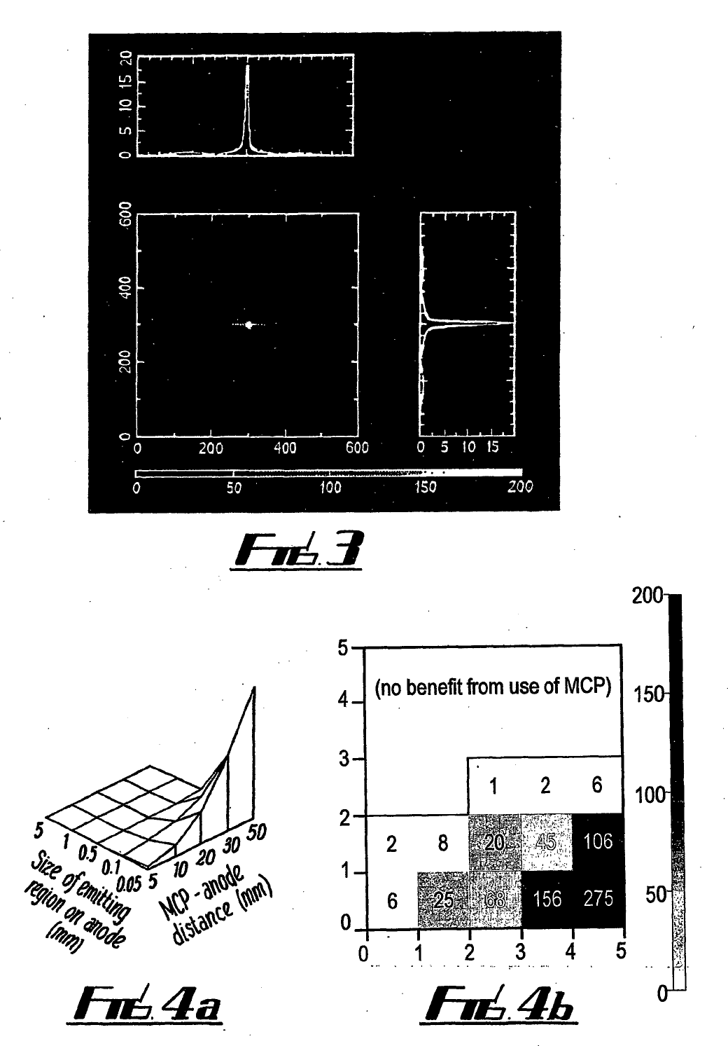

FIG. 3 shows a spot focus of Cu L X-rays.by a microchannel plate;

FIG. 4 shows a) gain as a function of source emitting region size and microchannel plate-anode distance and b) another representation of a);

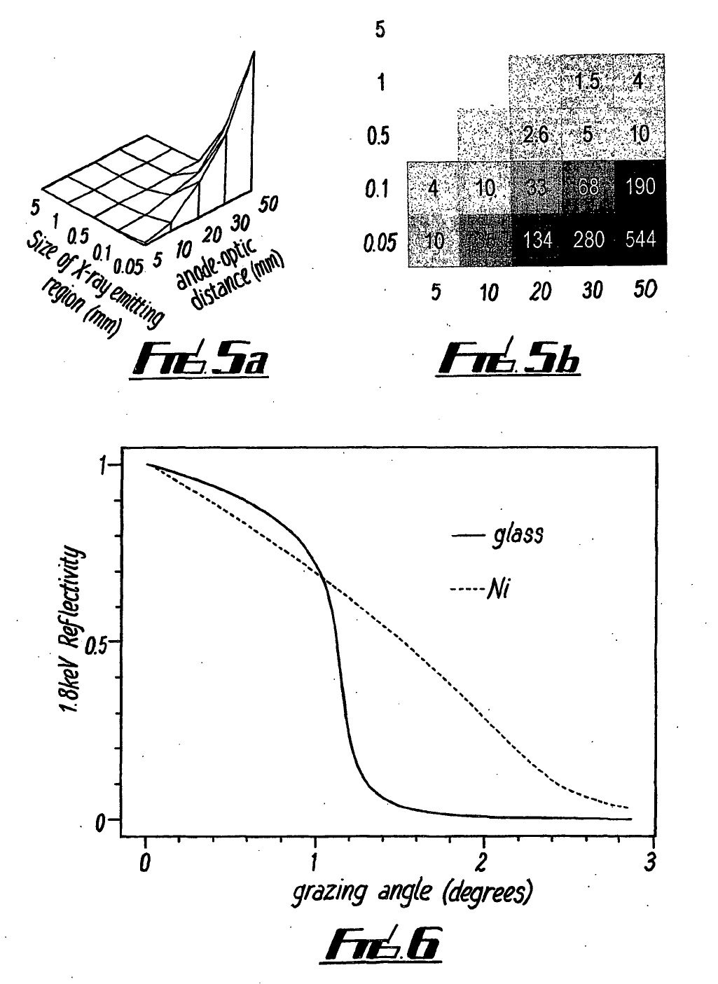

FIG. 5 shows a) gain as a function of source emitting region size and microchannel plate-anode distance for a nickel coated microchannel plate and b) another representation of a);

FIG. 6 shows reflectivity of 1.8 keV X-rays as a function of grazing angle for glass and nickel coated glass;

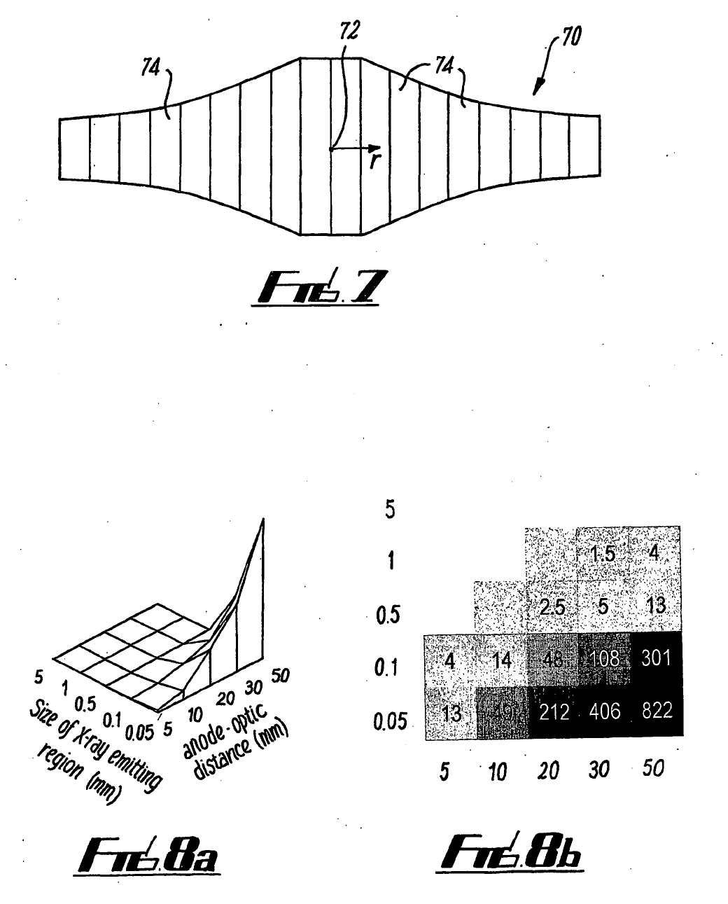

FIG. 7 is a cross sectional view of a microchannel plate of varying thickness;

FIG. 8 shows a) gain as a function of source emitting region size and microchannel plate-anode distance for a nickel coated microchannel of varying thickness and b) another representation of a);

FIG. 9 shows a) the focusing condition used in the definition of gain and b) the pinhole condition used in the definition of gain; and

FIG. 10 shows flux densities received by a sample a) positioned to receive X-rays from a generator of the present invention and b) positioned to receive X-rays from a conventional X-ray source.

FIG. 1 is a schematic diagram of an X-ray generator (shown generally at 10) of the present invention comprising:

a point or near point source of X-rays 12;

a microchannel plate optic 14 positioned with respect to the source of X-rays 12 so as to intercept a portion of the X-rays emitted by the source, and focus the intercepted X-rays to a spot 16 with a gain of greater than one.

The X-ray source can be of the known type in which an electron beam is directed at an anode, thereby producing X-rays of a characteristic energy. The X-rays are emitted with an isotropic angular distribution with respect to the electron beam. Suitable anodes include Al and Mg anodes, although many others are suitable and the invention is not limited in this regard. The electron beam is produced from electrons emitted by a nearby hot cathode, which are accelerated by a large potential difference (typically several kV) maintained between the anode and the cathode. The wavelength of X-rays produced is dependent on the material utilised as the anode and the voltage applied to the source. Representative X-ray energies are in the range 0.2 to 100 keV.

The microchannel plate optic 14 intercepts a portion of the emitted X-rays. The microchannel plate 14 is placed close to the source 12 so as to capture X-rays over a considerable solid angle and redirect them to a spot focus by equiangular reflection from the internal channel walls. If the source-microchannel distance is Ls, then the focus will be formed a distance Li=Ls on the other side of the optic. Typically, Ls is of the order of centimetres.

The microchannel plate optic 14 is of a configuration suitable for focusing X-rays. In one embodiment, the microchannel plate optic comprises a planar glass wafer possessing a plurality of parallel channels which are each of constant square cross section (ie, the channels do not taper). FIGS. 2a and 2b show SEM images of a suitable microchannel plate optic having many channels 20 with side walls 22. The microchannel plate optic 14 is flat, ie, as shown in FIG. 1, with a front face 14a which is substantially coplanar with back face 14b. In a non-limiting embodiment, a microchannel plate optic of this design can be used which is of dimensions 55×55 cm, and possesses glass channels of surface roughness ca. 1 nm. Such an optic can focus to an angular resolution of ca. 1 mrad FWHM. Furthermore, focusing has been demonstrated up to 60 keV. It may be possible to utilise this optic to focus higher energy X-rays still. Microchannel plates of this description are not mass produced commercially, but specialist manufacturers such as Photonis SA of Brive, France can produce such microchannel plates if provided with the desired specification. It should be noted that microchannel plates of different dimensions can be employed. In particular, microchannel plates of smaller dimensions (which are generally cheaper) can be used. For example, at an optic to sample separation of 50 mm, a microchannel plate of dimensions 6×6mm can be employed.

FIG. 3 shows an image from a microchannel plate optic of this type when used to focus Cu L X-rays (0.93 keV). Focusing is to ca. 1 mrad FWHM (full width at half maximum). A small degree of cross structure is observed which is due to X-rays reflected singly in the x or y direction only. However, the main central focus is much brighter and spatially better defined. This main focus is due to double x and y reflections.

Monte Carlo ray tracing simulations have indicated that a gain in spectral brightness of ˜50 times could be achieved using Al and Mg anodes and using MCPs of already demonstrated quality (angular full-width-at-half-maximum focus of ˜1 mrad, corresponding to a 0.1 mm FWHM spot at 10 cm) The coupling of an MCP optic to a conventional low power source may then give performance more typical of a rotating anode generator.

FIGS. 4a and b show that the results of simulations of the gain afforded by the apparatus of the present invention as a function of i) the size of the emitting region of the anode and ii) the microchannel plate optic to anode separation. The simulations are for a microchannel plate optic having the specific structural parameters described above. Very significant gains are shown: in fact, gains in intensity of greater than two. orders of magnitude are possible under suitable conditions. The most favourable gains are obtained when the X-ray source most closely approximates a point source, ie, when the size of the emitting region is less than 100 μm.

It is highly advantageous that high gains are observed at relatively large source-microchannel plate optic separations. At separations of greater than 20 mm a significant increase in gain is seen when the X-ray source is relatively small. The effect is particularly marked at separations of greater than 30 mm. It has been found that the high gains achieved at relatively large source-microchannel plate optic separations offset the reduction in X-ray flux reaching the microchannel plate optic at these separations. The reduction in flux incipient on the microchannel plate optic is a consequence of the inverse square law. FIG. 10 shows the X-ray flux incipient on a 50 μm diameter sample which is a) irradiated with X-rays focused by a generator of the present invention and b) directly irradiated with X-rays produced by a conventional X-ray source. Data corresponding to case a) are shown with a full line, whereas data corresponding to case b) are shown with a dotted line. It should be noted that the generator-sample distance shown in FIG. 10 is, in case b), the distance from the sample to the X-ray source itself In case a), the generator-sample distance is the distance from the sample to the microchannel plate optic. Owing to the focusing condition employed in case b), the generator-sample distance is equal to the source-microchannel plate optic separation. In case b), the flux density incipient on the sample drops vary markedly with increasing generator-sample distance due to the inverse square law. In contrast, in case a), the flux density incipient on the sample is remarkably constant over the range of generator-sample distances shown. Physically, this is because the high gains produced at large source-microchannel plate optic separations (and hence large generator-sample distances) compensate for the reduced flux density at the microchannel plate optic. The practical upshot is that samples do not need to be positioned very close to the generator. In some instances it is not possible to bring samples very close to the, generator: the present invention permits the interrogation of such samples. Additionally, the extra space between generator and sample afforded by the present invention reduces problems associated with cramped experimental geometry.

It should be noted that the maximum solid angle through which the microchannel plate optic can accept photons from the X-ray source is principally defined by the critical reflection angle. X-rays can only be reflected at grazing angles of ca. 1°, there being a sharp cut-off angle, the precise value of which depends on the reflecting surface and. the energy of the X-ray photons being focused. Any X-rays that strike the reflecting surface at a greater angle than the critical reflection angle will either be absorbed or pass through the optic unreflected.

Improvements in the gain can be obtained if a thin metal coating, such as a nickel coating, is deposited on the insides of the channels of the microchannel plate optic. In these circumstances, reflection of intercepted X-rays is possible at larger grazing angles than are possible with glass channels. FIGS. 5a and b show the gain which may be achieved by nickel coating the channels when the optic is coupled to a source of 1.49 eV X-rays. FIG. 6 shows the 1.8 keV reflectivity of glass and nickel coated glass as a function of grazing angle. It is apparent that nickel coated glass is capable of reflecting 1.8 keV X-rays at angles which exceed the critical reflection angle of glass. The thickness of the Ni coat is typically around 200 nm, although thicker coats can be employed.

Increases in gain can be achieved also by utilising a microchannel plate optic of variable thickness. FIG. 7 shows a preferred form of microchannel plate 70 having a plurality of channels 74 in which the thickness of the microchannel plate 70 varies as a function of the radial distance from the centre 72 of the microchannel plate 70 according to the profile L(r)=1.414. D.Ls/r, where r is the radial distance from the centre of the plate, L(r) is the channel length (which is equivalent to the plate thickness) as a function of r, D is the channel width, and L_{S} is the distance from the source to the centre of the plate (which is, additionally, equal to the distance from the centre of the plate to the sample under irradiation).

The variable thickness can be produced by appropriately grinding a flat microchannel plate optic. The profile defined above is preferred because it ensures that the grazing angle is always close to the ideal angle (defined by 1.414 D/L). This maximises the chances of an intercepted X-ray photon undergoing two orthogonal reflections, which in turn leads to focusing of the X-rays.

FIGS. 8a and b show the gain which may be achieved using a microchannel plate optic having a thickness profile according to the relationship defined above and nickel coated channels. Gains in excess of 800 are possible under certain conditions, principally those of small source size and large anode/optic separations.

There are numerous modifications to the invention which might be contemplated. As noted above, channel surfaces might be metal plated in order to improve efficiency. Different channel geometries might be used: radial packing, as opposed to square packing, may result in greater efficiency. Another possibility is to utilise curved, or “slumped”, microchannel plate optics, which could be used for magnification/demagnification purposes.

1. An optic coupled X-ray generator comprising:
a point or near point source of X-rays; and
a microchannel plate optic comprising a plurality of channels positioned with respect to the source of X-rays so as to intercept a portion of the X-rays emitted by the source, and to focus the intercepted X-rays to a spot with a gain of greater than one.

2. A generator according to claim 1 in which the microchannel plate optic is flat.

3. A generator according to claim 1 or claim 2 in which the thickness of the microchannel plate optic varies as a function of the radial distance from the centre of the optic.

4. A generator according to claim 3 when dependent on claim 2 in which the thickness of a microchannel plate optic varies substantially according to the function 1.414. D.Lₛ/r, where D is the width of the channels, Lₛ is the distance from the point source to the centre of the optic, and r is the radial distance from the centre of the optic.

5. A generator according to any of claims 1 to 4 in which the microchannel plate optic comprises a plurality of channels of square cross section, in which opposing sides of channels are parallel, and in which the longitudinal axes of the channels are parallel.

6. A generator according to any of claims 1 to 5 in which the distance between the source and the microchannel plate optic is in the range 0.5 to 20 cm, preferably in the range 2 to 12 cm.

7. A generator according to any previous claim in which the microchannel plate optic focuses the intercepted X-rays to a spot of less than 0.5 mm FWHM, preferably less than 0.25 mm FWHM, most preferably less than 0.15 mm FWHM.

8. A generator according to any of the previous claims in which the surfaces of the channels comprise a metal.

9. A generator according to claim 8 in which the metal is nickel.

10. A generator according to any previous claim in which the source of X-rays comprises an anode.

11. A generator according to claim 10 in which the anode comprises aluminium or magnesium.

12. A generator according to any previous claim adapted to focus the intercepted X-rays to a spot with a gain of greater than 30, preferably greater than 50, most preferably greater than 100.

13. The use of an optic X-ray generator according to any one of claims 1 to 12 in materials analysis, X-ray crystallography, dermatology or surface science.
